(19) United States
(12) Patent Application Publication
(10) Pub. No.: US 2021/0009448 A1
(43) Pub. Date: Jan. 14, 2021

(54) TREATMENT SYSTEM AND METHOD FOR RURAL BLACK AND ODOROUS WATER AND MANURE

(71) Applicants: Shen WANG, CHANGSHA (CN); HUNAN SAKAL ENVIRONMENTAL SCIENCE AND TECHNOLOGY CO., LTD., CHANGSHA (CN)

(72) Inventor: Shen WANG, CHANGSHA (CN)

(73) Assignee: HUNAN SAKAL ENVIRONMENTAL SCIENCE AND TECHNOLOGY CO., LTD.

(21) Appl. No.: 17/037,668

(22) Filed: Sep. 30, 2020

Related U.S. Application Data
(63) Continuation of application No. PCT/CN2018/094980, filed on Jul. 9, 2018.

(30) Foreign Application Priority Data
Jul. 2, 2018 (CN) 201810707886.1

(51) Int. Cl. C02F 1/54; C02F 11/16; C02F 11/10; C02F 1/52; C02F 9/00

(52) U.S. Cl. CPC C02F 1/54; C02F 11/16; C02F 2103/005; C02F 1/5209; C02F 9/00; C02F 11/10

(57) ABSTRACT

The present invention provides a treatment system and method for rural black and odorous water and manure. The treatment method includes: (1) sending manure into a solid-liquid separation system, adding straws and/or saw-dust and chaff to solid obtained after the solid-liquid separation, adjusting a carbon-nitrogen ratio, sending into a solid aerobic fermentation system for aerobic fermentation, and then aging to produce organic fertilizer; (2) sending liquid obtained after the solid-liquid separation into a liquid anaerobic fermentation system for deep anaerobic fermentation; (3) sending biogas slurry after the deep anaerobic fermentation to a bio-membrane filter tank and a fibrous filter tank for treatment; (4) irrigating crops with the treated liquid or reusing the treated liquid in the farmland; and (5) soaking straws in manure slurry of a straw hydrolysis tank for hydrolysis, then pumping the softened straws to the solid-liquid separation system by using a cutting pump.

### CROSS-REFERENCE TO RELATED APPLICATIONS

This application is a continuation of International Patent Application No. PCT/CN2018/094980 with a filing date of Jul. 9, 2018, designating the United States, now pending, and further claims priority to Chinese Patent Application No. 201810707886.1 with a filing date of Jul. 2, 2018. The content of the aforementioned applications, including any intervening amendments thereto, are incorporated herein by reference.

### TECHNICAL FIELD

The present invention belongs to the technical field of environment protection, and particularly relates to a treatment system and method for rural black and odorous water and manure.

### BACKGROUND OF THE PRESENT INVENTION

Black and odorous water is mainly caused by the pollution of human and animal manure and urine. Livestock and poultry breeding, especially the large-scale livestock and poultry breeding, generates a great amount of black and odorous sewage to be urgently managed.

On the basis of investigating the production field of the domestic livestock and poultry breeding industry and finding out the technology and equipment, resource utilization rate, pollutant generation indexes, waste recycling indexes and environment treatment of the livestock and poultry breeding pollution prevention and control process, the National Ministry of Environmental Protection issued “HJ-BAT-10 Guidelines on Optimal Feasible Techniques for Pollution Prevention and Control of Livestock and Poultry Breeding (Trial)” on July 2013 by comparing and analyzing the technical economy and fully borrowing the successful experience of the developed countries (such as USA, EU, etc.) in the livestock and poultry breeding pollution prevention and control system.

The existing treatment technology of the livestock and poultry farms has the following problems:

1. The used anaerobic treatment technology (UASB, CSTR and URS) requires large investment.

2. According to the provisions of “HJ-BAT-10 Guidelines on Optimal Feasible Techniques for Pollution Prevention and Control of Livestock and Poultry Breeding (Trial)”, the biogas slurry needs to be stored for no less than 90 days when it is reused in farmland, and needs to be received by larger fields and containers.

3. Even with the above standard anaerobic treatment and 90-day storage, it still cannot meet the requirements of “GB5084-2005 Farmland Irrigation Water Quality Standard”.

Therefore, the existing treatment technology for the pollution of livestock and poultry farms has the problems of large investment and incapability of meeting the requirements of the manure treatment provisions.

In addition, after the on-site burning of the straws nearby the farmland is forbidden, the recycling of the straws is difficult. The sun-dried and crushed straws are good raw materials for composting, but have high requirements for storage conditions. Strictly following the sun-drying and crushing process, the cost is too high, and the straws cannot become the continuous and stable raw materials for the composting.

The anaerobic fermentation for the pure manure slurry has the problems of excessively low carbon-nitrogen ratio, affecting the gas production and microbiological degradation.

### SUMMARY OF PRESENT INVENTION

The technical problem to be solved by the present invention is to solve the problems in the prior art that the cost is high, the water quality of the treated sewage cannot meet the farmland irrigation water quality standard and the rural straws are difficult to treat, and to provide a treatment system and method for rural black and odorous water and manure, which thoroughly solves the pollution problems of large-scale livestock and poultry breeding and the treatment problem of rural straws by adopting a novel combined technology, and converts pollution into resources to realize the cyclic utilization of resources.

The technical solutions adopted by the present invention are as follows:

A treatment method for rural black and odorous water and manure includes:

(1) sending manure into a solid-liquid separation system, adding an appropriate amount of straws and/or saw-dust and chaff into solid obtained after the solid-liquid separation, adjusting a carbon-nitrogen ratio to 20-30 and water content to 50%-70%, then sending into a solid aerobic fermentation system for aerobic fermentation, and then aging to obtain organic fertilizer;

(2) sending the manure into the solid-liquid separation system, homogenizing liquid obtained after the solid-liquid separation by a regulating tank, and sending into a liquid anaerobic fermentation system for deep anaerobic fermentation;

(3) sending biogas slurry after the deep anaerobic fermentation in step (2) to a bio-membrane filter tank for aerobic biochemical treatment, sending sewage treated by the bio-membrane filter tank into a fibrous filter tank for filtering, and making the sewage reach requirements of relevant farmland irrigation water quality standard and emission standard;

(4) carrying out the water-fertilizer integrated irrigation for peripheral crops using one part of the liquid treated in step (3), and sterilizing the other part to be reused for flushing fences;

(5) in a region where the straws can be collected, arranging straw hydrolysis tanks, loading the manure slurry into the straw hydrolysis tanks, cutting the straws into segments, soaking the straw segments in manure slurry of the straw hydrolysis tanks for hydrolysis, wherein the straw hydrolysis tanks are multiple; after the straws soaked in one straw hydrolysis tank reach the soaking time, pumping the softened straws into the solid-liquid separation system by using a cutting pump, mixing the straws obtained from the solid-liquid separation with manure, adjusting the carbon-nitrogen ratio to 20-30, and sending to the solid aerobic fermentation system for aerobic fermentation to produce organic fertilizer; and homogenizing the liquid obtained from the solid-liquid separation by the regulating tank, sending to the liquid anaerobic fermentation for anaerobic fermentation, carrying out the aerobic biochemical treatment in the bio-membrane filter tank, then sending into the fibrous filter tank for filtering, and making the sewage meet the requirements of relevant farmland irrigation water quality standard and emission standard.

A treatment system for the rural black and odorous water and manure includes a solid-liquid separation system, a solid aerobic fermentation system, a liquid anaerobic fermentation system, a bio-membrane filter tank, a fibrous filter tank, a cutting pump, connection pipelines and a straw hydrolysis tank; a manure outlet is connected with the solid-liquid separation system and/or the manure outlet is connected with the straw hydrolysis tank, and straws of the straw hydrolysis tank are conveyed to the solid-liquid separation system through the cutting pump and the connection pipeline; solid of the solid-liquid separation system is conveyed to the solid aerobic fermentation system, and the output of the solid aerobic fermentation system is aged to produce the organic fertilizer; and liquid separated from the solid-liquid separation system is outputted to the regulating tank, sewage of the regulating tank is connected and conveyed to the liquid anaerobic fermentation system, biogas slurry outputted by the liquid anaerobic fermentation system is connected to the bio-membrane filter tank, the sewage treated by the bio-membrane filter tank is sent to the fibrous filter tank, and the filter water of the fibrous filter tank is used for farmland irrigation or reuse.

In the above technical solutions, the solid-liquid separation system includes a spiral squeezing solid-liquid separator and an inclined-sieve solid-liquid separator. The liquid squeezed by the spiral squeezing solid-liquid separator is conveyed to the inclined-sieve solid-liquid separator for continuous solid-liquid separation.

In the above technical solutions, the liquid anaerobic fermentation system is formed by connecting N anaerobic soft boigas digesters in series; N≥1; when the quantity of the anaerobic soft biogas digesters is greater than 1, the first anaerobic soft biogas digester with liquid feed is an anaerobic hydrolysis acidification tank, and the total capacity of the anaerobic soft biogas digesters connected in series is designed to be ten times or more than ten times of the liquid volume fed everyday to ensure the full anaerobic fermentation of the produced liquid; the bottoms of the biogas digesters descend gradually, the bottom of the previous anaerobic soft biogas digester has a sludge guiding pipeline connected with the next anaerobic soft biogas digester, so that sludge settled in the previous biogas digester flows to the next biogas digester through the sludge guiding pipeline; and a sludge discharging pipe arranged at a lowest position on the bottom of each anaerobic soft biogas tank can periodically discharge the sludge to prevent the accumulation of the sludge inside the anaerobic soft biogas digester, and the supernatant of the last biogas digester flows into the bio-membrane filter tank.

In the above technical solutions, biogas generated by the liquid anaerobic fermentation system provides a heat source to a reactor of the solid aerobic fermentation system for realizing the high-temperature aerobic fermentation and/or provides the heat source to the liquid anaerobic fermentation system for realizing medium-temperature anaerobic fermentation, and provides the heat source to breeding sheds for livestock and poultry breeding.

In the above technical solutions, the bio-membrane filter tank refers to a bio-turnplate bio-membrane biochemical reactor or a submerged lifting cycling bio-membrane filter tank.

In the above technical solutions, the submerged lifting cycling bio-membrane filter tank adopts two groups of filter screens which have equal weight and are symmetrically and alternately distributed. Under the action of a lifting mechanism, the two groups of filter screens rise and fall periodically in the bio-membrane filter tank, so that bio-membranes on the two groups of filter screens contact the air and sewage in turn. The bio-membranes absorb organic matters in the sewage when descending and submerging, and absorb oxygen when rising in the air so as to bring the oxygen into the sewage during the next descending and submerging and to cause the turbulence of the sewage in a water channel, so that the dissolved oxygen is uniformly distributed, and the sewage is purified.

In the above technical solutions, the fibrous filter tank adopts a reciprocating-suction fibrous filter tank. Filter holes are symmetrically arranged between a sewage tank and a filtrate tank. A filter plate is installed and fixed on the filter holes. Sewage in the sewage tank is filtered by the filter plate to enter the filtrate tank. One side of the sewage tank of the filter plate is provided with a sludge sucker. The sludge sucker makes up-down or horizontal synchronous motion in opposite directions to suck the sludge under the action of the driving mechanism. When the filter plate is blocked, the liquid level of the sewage in the sewage tank rises; and when the liquid level of the sewage in the sewage tank reaches a liquid level set by a liquid sensor, an electric control system controls and starts the sludge sucker to back suck the sludge on the filter plate and also starts the driving mechanism to drive the sludge sucker to make up-down or horizontal synchronous motion in opposite directions to suck away the sludge on the filter plate, so that the filter plate can restore the filter capacity.

In the above technical solutions, the straw hydrolysis tank is an ordinary water tank. The water tank is subjected to the anti-seepage treatment. The straw hydrolysis tank plays a role in soaking feces and straws, so that the straws are hydrolyzed and softened.

In the above technical solution, the regulation tank is an ordinary water tank. The water tank is, treated to prevent the leakage and has a main function of homogenizing the liquid entering the anaerobic fermentation system and uniformly stabilizing the liquid output, thereby facilitating the subsequent anaerobic fermentation and stable biochemical treatment of the bio-membrane method.

In the above technical solutions, the solid aerobic fermentation system includes an aerobic fermentation reactor, a cycling water or cycling oil system, an air intake and exhaust system, a detection system and a control system. A horizontal roller of the aerobic fermentation reactor is provided with a water sleeve, and two side sealing caps of the horizontal roller are provided with a material inlet, a material outlet and an air inlet and a vent hole. The cycling water or cycling oil system is connected and communicated with the water sleeve on the horizontal roller, and the air intake and exhaust system is connected and communicated with the air inlet and the vent hole on the sealing caps of the horizontal roller. The detection system is provided with a temperature detection apparatus on a water inlet pipe and a water outlet pipe of the aerobic fermentation reactor. A material outlet side of the aerobic fermentation reactor is provided with an oxygen content detection apparatus, and a material temperature detection apparatus is arranged in the aerobic fermentation reactor. The detection apparatus outputs a detection signal to a control system. The control system controls the cycling water or cycling oil system, the air intake and exhaust system, the aerobic fermentation reactor and an outer feeding and unloading apparatus.

In the above technical solutions, the straws are cut into straw segments with a length of 1-3 cm.

In the above technical solutions, the liquid obtained after the solid-liquid separation is sent into the liquid anaerobic fermentation system for deep anaerobic fermentation for more than 20 days.

In the above technical solutions, the “aging” of the organic fertilizer produced by aging is the known technology. The anaerobic soft biogas digester is the known technology. The anaerobic hydrolysis acidification tank is also the known technology.

The present invention has the beneficial effects:

1. The manure polluting the environment is recycled. The solid in the manure is converted into the organic fertilizer for improving the soil, while the manure slurry treatment can reach relevant standards. In the region where the water-fertilizer integrated irrigation can be carried out, the sewage is treated to reach the farmland irrigation water quality standard for farmland irrigation and reuse. In the region without the condition of farmland irrigation, in this process, by prolonging the anaerobic fermentation time, increasing the treatment levels of the bio-membrane method and filtering the substances in the sewage that cannot be treated by the anaerobic and aerobic bio-membrane method through the fibrous membrane so as to filter pollutants, so that the sewage treatment reaches relevant emission standards, and the pollution problem of the black and odorous water and manure can be thoroughly solved;

2. The optimized treatment technology of the present invention has the remarkable characteristics such as low cost and good treatment effect;

3. The optimized bio-membrane method sewage treatment technology of the present invention does not need the reflux of the sludge, does not need the blast aeration and does not have the sludge expansion problem, so that the technicians do not need to adjust the sludge reflux amount and aeration amount according to the changes in weather, temperature, sewage pollution degree and biodegradability, the operation and maintenance are simple, the talent bottleneck for managing the rural environment can be broken through, and the operation and maintenance and treatment cost can be greatly reduced;

4. Since the blast aeration and sludge reflux are not needed, the energy consumption for the system operation is, extremely low;

5. The biogas generated by the soft biogas digester can provide heat to the system and livestock and poultry breeding, thereby greatly reducing the corresponding energy consumption;

6. The present invention provides a solution for recycling the straws, that is, part of the straw is sun-dried and crushed to adjust the carbon-nitrogen ratio and water content of the manure aerobic composting, and the other part of the straw that cannot be sun-dried is directly placed into the straw hydrolysis tank to be soaked in the manure, thereby providing sufficient nutrients for the anaerobic fermentation of the sewage, and promoting the biodegradability of the anaerobic treatment. While the raw material is provided for the aerobic compositing, the yield of the biogas is also increased, so that the straws can be thoroughly recycled.

### DESCRIPTION OF THE DRAWINGS

FIG. 1 is a flow chart of the present invention;

FIG. 2 is a structural diagram of an embodiment of a solid aerobic fermentation system of the present invention;

FIG. 3 is a structural diagram of an embodiment of a liquid anaerobic fermentation system of the present invention;

FIG. 4 is a structural diagram of an embodiment of a bio-membrane filter tank of the present invention;

FIG. 5 is a structural diagram of embodiment 1 of a fibrous filter tank of the present invention;

FIG. 6 is an A-A view of FIG. 5;

FIG. 7 is a structural diagram of embodiment 2 of the fibrous filter tank of the present invention;

FIG. 8 is a B-B view of FIG. 7;

FIG. 9 is a flow chart of a combination I of optimal feasible technologies for anaerobic digestion of livestock and poultry manure in the prior art; and

FIG. 10 is a flow chart of a combination II of optimal feasible technologies for anaerobic digestion of livestock and poultry manure in the prior art;

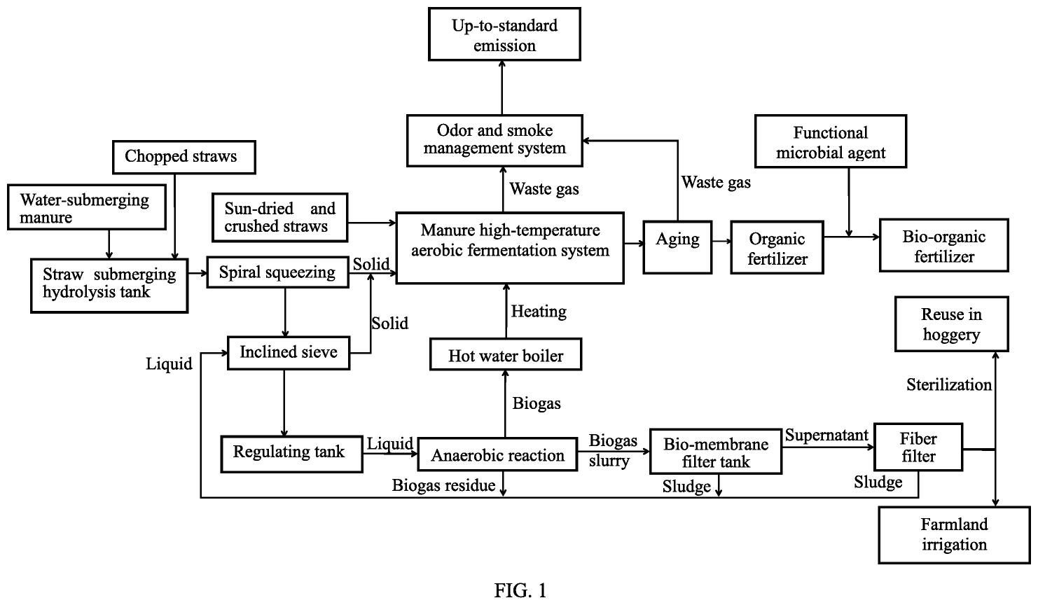

### DESCRIPTION OF NUMERALS IN THE DRAWINGS

1—Spiral feeding machine; 2—exhaust pipe; 3—left side sealing cap; 4—bearing inner ring; 5—bearing outer ring; 6—cylinder fermenter; 7—shoveling plate; 8—glove connection pipe; 9—heat exchanging water sleeve; 10—insulating layer; 11—water sleeve water inlet pipe; 12—right side sealing cap; 13—air intake pipe; 14—right-handed connector; 15—cycling water inlet pipe; 16—spiral discharging machine; 17—right carrier roller group; 18—supporting steel ring; 19—electric motor; 20—coupler; 21—speed reducer; 22—small gear; 23—outer gear ring; 24—left carrier roller group; 25—sealing ring; 26—water sleeve water outlet pipe; 27—left-handed connector; 28—cycling water outlet pipe; 29—liquid inlet pipe; 30—first anaerobic soft biogas digester; 31—sludge guiding pipeline; 32—second anaerobic soft biogas digester; 33—supernatant discharging pipe; 34—bio-membrane filter tank; 35—liquid discharging pipe; 36—fibrous filter tank; 37—submerged lifting cycling bio-membrane filter tank; 38—bio-membrane filter screen A; 39—bio-membrane filter screen B; 40—bearing frame; 41—lifting mechanism; 42—water inlet groove; 43—sewage tank; 44—filtrate tank; 45—water outlet channel; 46—filter plate A; 47—filter plate B; 48—sludge sucker A; 49—sludge sucker B; 50—lifting mechanism; 51—fibrous filter tank lifting guide rail A; 52—fibrous filter tank lifting guide rail B; 53—fibrous filter tank lifting guide rail C; 54—limiting sensor; 55—liquid level sensor; 56—settled sludge pump; 57—effluent weir; 58—transition power; 59—transition guide rail.

### DETAILED DESCRIPTION OF PREFERRED EMBODIMENTS

By referring to the figures, a treatment method for rural black and odorous water and manure in the present invention includes:

(1) sending manure into a solid-liquid separation system, adding an appropriate amount of straws and/or saw-dust and chaff into solid obtained after the solid-liquid separation, adjusting a carbon-nitrogen ratio to 20-30 and water content to 50%-70%, then sending into a solid aerobic fermentation system for aerobic fermentation, and then aging to obtain organic fertilizer;

(2) sending the manure into the solid-liquid separation system, homogenizing liquid obtained after the solid-liquid separation by a regulating tank, and sending into a liquid anaerobic fermentation system for deep anaerobic fermentation;

(3) sending biogas slurry after the deep anaerobic fermentation in step (2) to a bio-membrane filter tank for aerobic biochemical treatment, sending sewage treated by the bio-membrane filter tank into a fibrous filter tank for filtering, and making the sewage reach requirements of relevant farmland irrigation water quality standard and emission standard;

(4) carrying out the water-fertilizer integrated irrigation for peripheral crops using one part of the liquid treated in step (3), and sterilizing the other part to be reused for flushing fences;

(5) in a region where the straws can be collected, arranging straw hydrolysis tanks, loading the manure slurry into the straw hydrolysis tanks, cutting the straws into segments, soaking the straw segments in manure slurry of the straw hydrolysis tanks for hydrolysis, wherein the straw hydrolysis tanks are multiple; after the straws soaked in one straw hydrolysis tank reach the soaking time (soaking time required for different straws is different), pumping the softened straws into the solid-liquid separation system by using a cutting pump, mixing the straws obtained from the solid-liquid separation with manure, adjusting the carbon-nitrogen ratio to 20-30, and sending to the solid aerobic fermentation system for aerobic fermentation to produce organic fertilizer; and homogenizing the liquid obtained from the solid-liquid separation by the regulating tank, sending to the liquid anaerobic fermentation for anaerobic fermentation, carrying out the aerobic biochemical treatment in the bio-membrane filter tank, then sending into the fibrous filter tank for filtering, and making the sewage meet the requirements of relevant farmland irrigation water quality standard and emission standard.

A treatment system for the rural black and odorous water and manure includes a solid-liquid separation system, a solid aerobic fermentation system, a liquid anaerobic fermentation system, a bio-membrane filter tank, a fibrous filter tank, a cutting pump, connection pipelines and a straw hydrolysis tank; a manure outlet is connected with the solid-liquid separation system and/or the manure outlet is connected with the straw hydrolysis tank, and straws of the straw hydrolysis tank are conveyed to the solid-liquid separation system through the cutting pump and the connection pipeline; solid of the solid-liquid separation system is conveyed to the solid aerobic fermentation system, and the output of the solid aerobic fermentation system is aged to produce the organic fertilizer; and liquid separated from the solid-liquid separation system is outputted to the regulating tank, sewage of the regulating tank is connected and conveyed to the liquid anaerobic fermentation system, biogas slurry outputted by the liquid anaerobic fermentation system is connected to the bio-membrane filter tank, the sewage treated by the bio-membrane filter tank is sent to the fibrous filter tank, and the filter water of the fibrous filter tank is used for farmland irrigation or reuse.

The solid-liquid separation system includes a spiral squeezing solid-liquid separator and an inclined-sieve solid-liquid separator. The liquid squeezed by the spiral squeezing solid-liquid separator is conveyed to the inclined-sieve solid-liquid separator for continuous solid-liquid separation. The solid and the liquid are conveyed to the solid aerobic fermentation system, and the liquid is conveyed to the regulating tank.

The liquid anaerobic fermentation system is formed by connecting N anaerobic soft boigas digesters in series; N≥1; when the quantity of the anaerobic soft biogas digesters is greater than 1, the first anaerobic soft biogas digester with liquid feed is an anaerobic hydrolysis acidification tank, and the total capacity of the anaerobic soft biogas digesters connected in series is designed to be ten times or more than ten times of the liquid volume fed everyday to ensure the full anaerobic fermentation of the produced liquid; the bottoms of the biogas digesters descend gradually, the bottom of the previous anaerobic soft biogas digester has a sludge guiding pipeline connected with the next anaerobic soft biogas digester, so that sludge settled in the previous biogas digester flows to the next biogas digester through the sludge guiding pipeline; and a sludge discharging pipe arranged at a lowest position on the bottom of each anaerobic soft biogas tank can periodically discharge the sludge to prevent the accumulation of the sludge inside the anaerobic soft biogas digester, and the supernatant of the last biogas digester flows into the bio-membrane filter tank.

Biogas generated by the liquid anaerobic fermentation system provides a heat source to a reactor of the solid aerobic fermentation system for realizing the high-temperature aerobic fermentation and/or provides the heat source to the liquid anaerobic fermentation system for realizing medium-temperature anaerobic fermentation, and provides the heat source to breeding sheds for livestock and poultry breeding.

The bio-membrane filter tank refers to a bio-turnplate bio-membrane biochemical reactor or a submerged lifting cycling bio-membrane filter tank.

The submerged lifting cycling bio-membrane filter tank adopts two groups of filter screens which have equal weight and are symmetrically and alternately distributed. Under the action of a lifting mechanism, the two groups of filter screens rise and fall periodically in the bio-membrane filter tank, so that bio-membranes on the two groups of filter screens contact the air and sewage in turn. The bio-membranes absorb organic matters in the sewage when descending and submerging, and absorb oxygen when rising in the air so as to bring the oxygen into the sewage during the next descending and submerging and to cause the turbulence of the sewage in a water channel, so that the dissolved oxygen is, uniformly distributed, and the sewage is, purified.

The fibrous filter tank adopts a reciprocating-suction fibrous filter tank. Filter holes are symmetrically arranged between a sewage tank and a filtrate tank. A filter plate is installed and fixed on the filter holes. Sewage in the sewage tank is filtered by the filter plate to enter the filtrate tank. One side of the sewage tank of the filter plate is provided with a sludge sucker. The sludge sucker makes up-down or horizontal synchronous motion in opposite directions to suck the sludge under the action of the driving mechanism. When the filter plate is blocked, the liquid level of the sewage in the sewage tank rises; and when the liquid level of the sewage in the sewage tank reaches a liquid level set by a liquid sensor, an electric control system controls and starts the sludge sucker to back suck the sludge on the filter plate and also starts the driving mechanism to drive the sludge sucker to make up-down or horizontal synchronous motion in opposite directions to suck away the sludge on the filter plate, so that the filter plate can restore the filter capacity.

The straw hydrolysis tank is an ordinary concrete water tank. The water tank is subjected to the anti-seepage treatment. The straw hydrolysis tank plays a role in soaking feces and straws, so that the straws are hydrolyzed and softened.

The regulation tank is an ordinary concrete water tank. The water tank is subjected to the anti-seepage treatment and has a main function of homogenizing the liquid entering the anaerobic fermentation system and uniformly stabilizing the liquid output, thereby facilitating the subsequent anaerobic fermentation and stable biochemical treatment of the bio-membrane method.

The solid aerobic fermentation system includes an aerobic fermentation reactor, a cycling water or cycling oil system, an air intake and exhaust system, a detection system and a control system. A horizontal roller of the aerobic fermentation reactor is provided with a water sleeve, and two side sealing caps of the horizontal roller are provided with a material inlet, a material outlet and an air inlet and a vent hole. The cycling water or cycling oil system is connected and communicated with the water sleeve on the horizontal roller, and the air intake and exhaust system is connected and communicated with the air inlet and the vent hole on the sealing caps of the horizontal roller. The detection system is provided with a temperature detection apparatus on a water inlet pipe and a water outlet pipe of the aerobic fermentation reactor. A material outlet side of the aerobic fermentation reactor is provided with an oxygen content detection apparatus, and a material temperature detection apparatus is arranged in the aerobic fermentation reactor. The detection apparatus outputs a detection signal to a control system. The control system controls the cycling water or cycling oil system, the air intake and exhaust system, the aerobic fermentation reactor and an outer feeding and unloading apparatus.

The straws are cut into straw segments with a length of 1-3 cm.

The liquid obtained after the solid-liquid separation is sent into the liquid anaerobic fermentation system for deep anaerobic fermentation for more than 20 days.

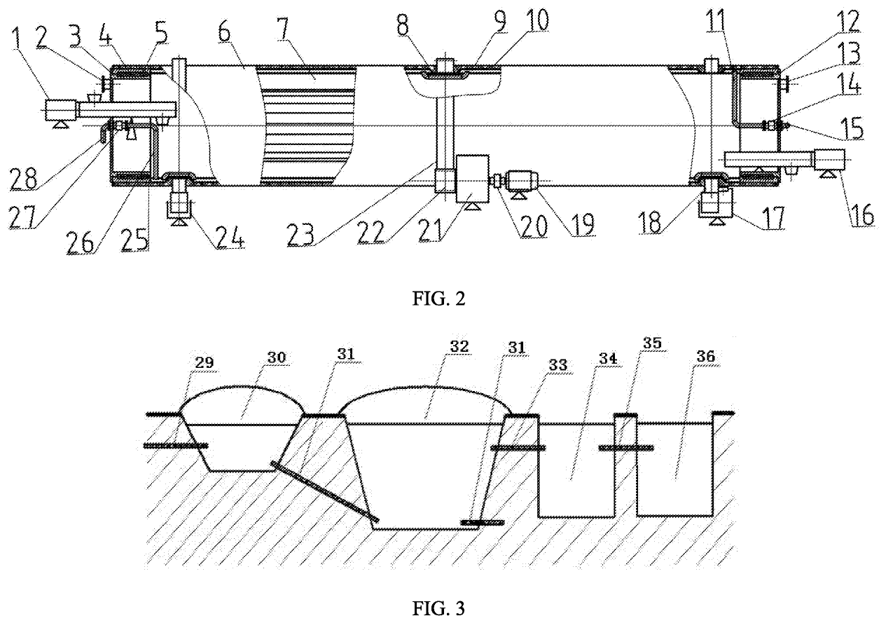

Referring to FIG. 2 (a structural diagram of an embodiment of a solid aerobic fermentation system of the present invention), the solid aerobic fermentation system adopts a horizontal roller rolling-type aerobic fermentation device with a heat exchanger and adopts a structure as follows: a horizontal cylinder fermenter is supported by a carrier roller group. The left end and the right end of the cylinder fermenter are respectively provided with a bearing. Two ends of the cylinder fermenter are connected with a left side sealing cap and a right side sealing cap through a bearing outer ring and a bearing inner ring. The cylinder fermenter, the bearings and the sealing caps form a closed fermentation space. A spiral feeding machine, an exhaust pipe, a spiral discharging machine and an air intake pipe are separately installed on the left side sealing cap and the right side sealing cap. A cylindrical heat exchanging water sleeve is coaxially arranged outside the cylinder fermenter. An electric motor, a coupler, a speed reducer and a small gear are connected in sequence. The small gear is engaged with an outer gear ring on the cylinder fermenter.

Referring to FIG. 3 (a structural diagram of an embodiment of a liquid anaerobic fermentation system of the present invention), in FIG. 3, an anaerobic soft biogas digester is a known technology. In the present invention, two anaerobic soft biogas digesters are connected in series.

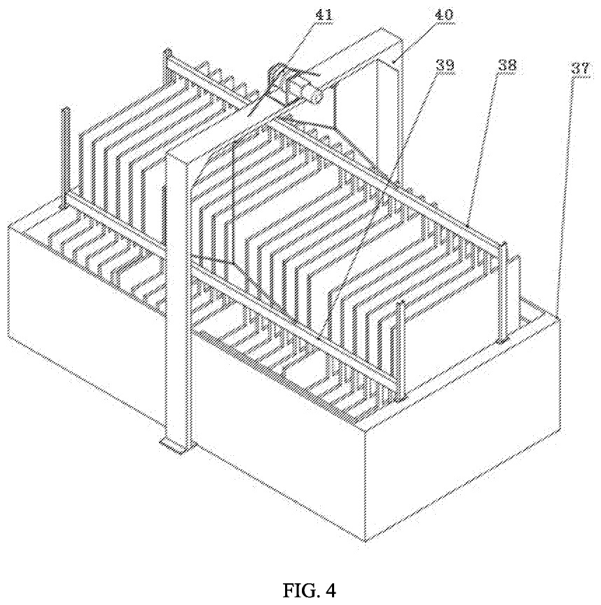

Referring to FIG. 4 (structural diagram of embodiments of a bio-membrane filter tank of the present invention), a bio-membrane filter tank of the present invention adopts a submerged lifting cycling bio-membrane filter tank. The submerged lifting cycling bio-membrane filter tank includes a bio-membrane filter tank, a bearing frame, two groups of filter screens with equal weight, a lifting mechanism, a pulley block and two groups of anti-swing guide rails. The lifting mechanism is installed on a middle position above a crossbeam of the bearing frame, and the bearing frame stretches across above the bio-membrane filter tank and is fixed on the ground or on a bio-membrane filter tank body. The pulley block is suspended on the crossbeam of the bearing frame. The lifting mechanism adopts a driving mechanism to be connected with two groups of filter screens in a driving manner by adopting a pulling rope assembly to pass through the pulley block. The two groups of anti-swing guide rails are respectively arranged on corresponding positions of two ends of hanging beams of the two groups of filter screens.

A treatment process of the submerged lifting cycling bio-membrane filter tank is as follows: two groups of filter screens which have equal weight and are symmetrically and alternately distributed are adopted. Under the action of the lifting mechanism, the two groups of filter screens rise and fall periodically in the bio-membrane filter tank, so that bio-membranes on the two groups of filter screens contact the air and sewage in turn. The bio-membranes absorb organic matters in the sewage when descending and submerging, and absorb oxygen when rising in the air so as to bring the oxygen into the sewage during the next descending and submerging and to cause the turbulence of the sewage in a water channel, so that the dissolved oxygen is uniformly distributed, and the sewage is purified.

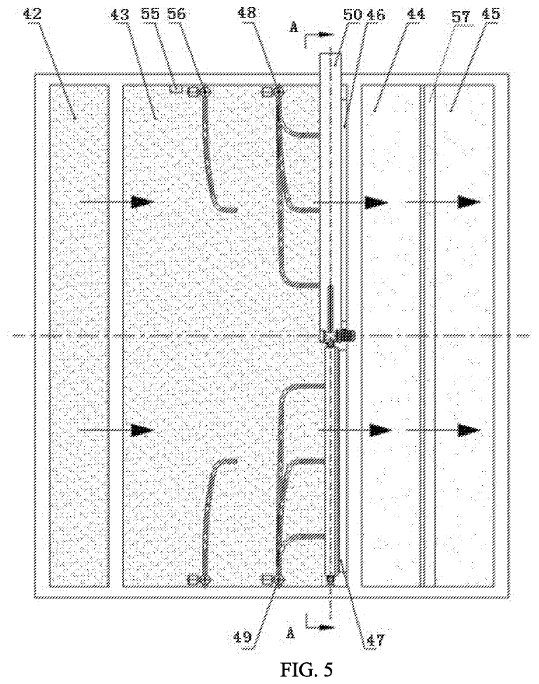

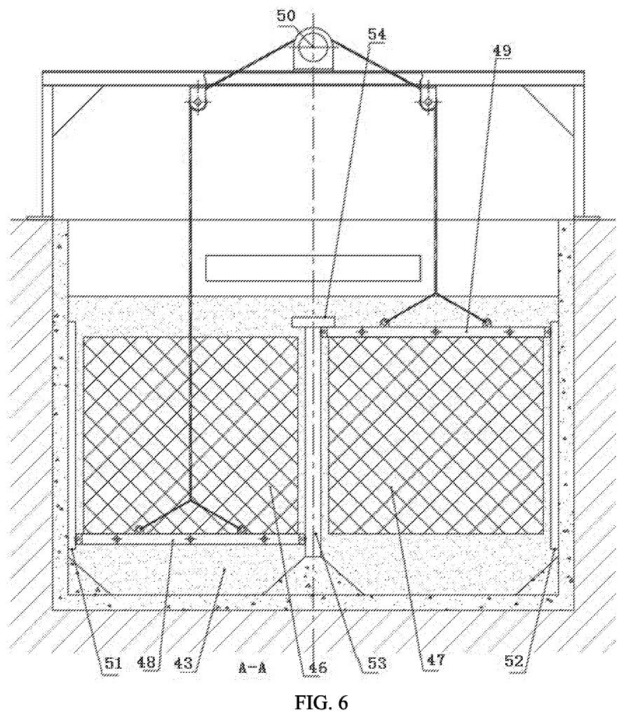

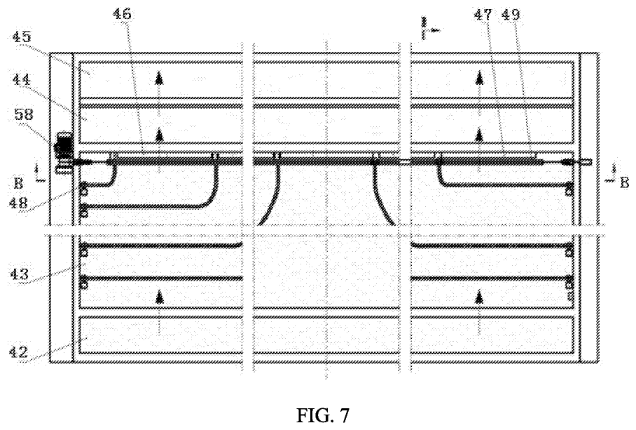

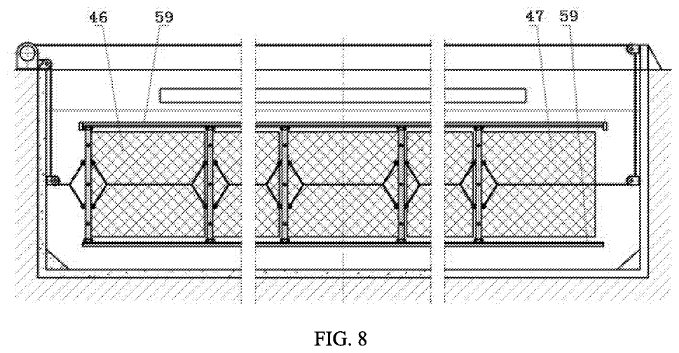

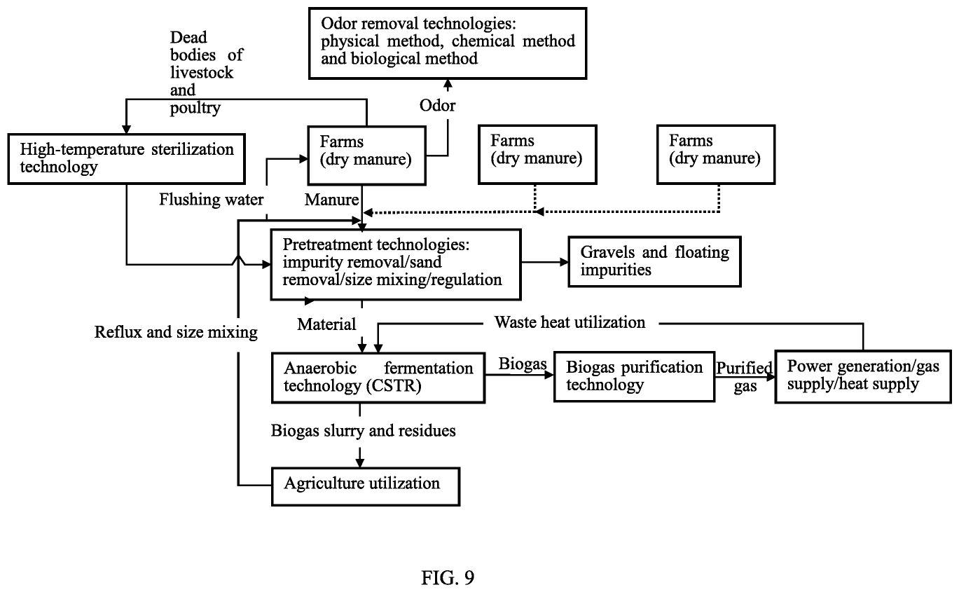

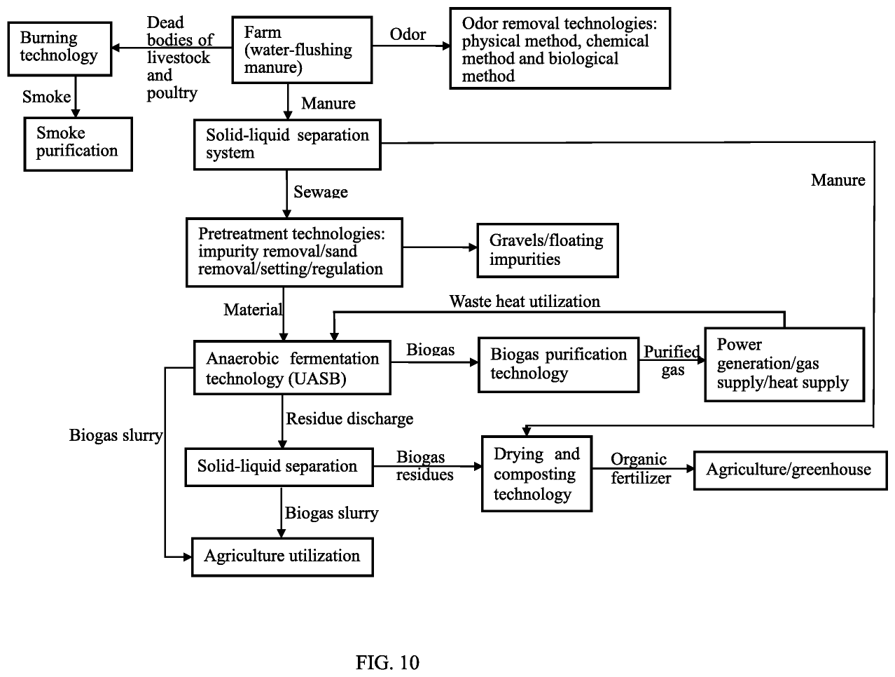

Referring to FIG. 5-FIG. 8 showing the structural diagrams of embodiments 1 and 2 of a fibrous filter tank of the present invention, as shown in FIG. 5 and FIG. 6, embodiment 1 is a reciprocating lifting back-suction fibrous filter tank. As shown in FIG. 7 and FIG. 8, embodiment 2 is a reciprocating horizontal back-suction fibrous filter tank. The specific structure is as follows: the two reciprocating back-suction fibrous filter tanks each includes a sewage tank, a filtrate tank, a filter plate, a sludge sucker and a driving mechanism; and the sewage tank is connected with the filtrate tank. The junction between the sewage tank and the filtrate tank is provided with filter holes. The filter plate is fixedly installed on the filter holes. One side of the sewage tank of the filter plate is correspondingly provided with the sludge sucker, and the sludge sucker is close to the filter plate. The sludge sucker is connected with the driving mechanism and driven by the driving mechanism to make up-down or horizontal synchronous motion in opposite directions to suck the sludge.

The reciprocating lifting back-suction fibrous filter tanks are shown in FIG. 5 and FIG. 6. The driving mechanism of the reciprocating lifting back-suction fibrous filter tank includes a lifting mechanism. The bottom of the sewage tank is provided with a slope. A settled sludge pump is arranged in the sewage tank, and the inlet end of a sludge suction pipe of the settled sludge pump is arranged on the bottom of the sewage tank. The lifting mechanism includes a bearing frame, a lifting driving apparatus, a pulley and a pulling rope. The bearing frame is a portal structure, and two ends of the bearing frame are respectively installed and fixed on tank bodies at two sides of the sewage tank. The lifting driving apparatus is installed on a center position of a crossbeam of the bearing frame. The lifting driving apparatus is connected with the pulling rope, and two ends of the pulling rope respectively pass through the two pulleys to be connected with the two groups of sludge suckers. The pulling rope is driven by the driving lifting mechanism to pull the two groups of sludge suckers to make synchronous up-down motion in opposite directions one above the other.

The sludge sucker in FIG. 5 and FIG. 6 includes a sludge suction pump, a sludge suction head, a sludge suction pipe and sludge suction nozzles. The sludge suction pump is connected and communicated with the sludge suction head through the sludge suction pipe. A plurality of sludge suction nozzles are uniformly distributed at one side of the sludge suction head close to filter cloth. The sludge suction nozzles are close to the filter cloth, and the sludge suction range thereof covers the filter cloth. A highest position of the sludge suction head is equal to or slightly higher than the upper edge of the filter plate, and a lowest position of the sludge suction nozzle is equal to or slightly lower than the lower edge of the filter plate. Two ends of the sludge suction head of the sludge sucker are provided with a lifting guide roller, and correspondingly two ends of the sludge suction nozzle of the sewage tank are provided with a vertical lifting guide rail. The lifting guide rollers on two ends of the sludge suction head are sleeved in the lifting guide rails. The upper portion of the sewage tank is provided with a liquid level sensor. The upper portion of the lifting guide rail is provided with a limiting sensor limiting a travel distance of the sludge sucker.

The reciprocating lifting back-suction fibrous filter tank is shown in FIG. 7 and FIG. 8. Its driving mechanism includes a horizontal driving mechanism. The horizontal driving mechanism includes a transition power, a pulley block and a pulling rope. The transition power is installed and fixed at one side of the sewage tank. The pulley block is fixed on the wall of the sewage tank. The pulling rope bypasses the transition power. Two ends of the pulling rope pass through each pulley of the pulley block respectively to be connected with two horizontal ends of the sludge sucker group. The pulling rope is driven by the transition power to drive the sludge sucker group to make horizontal reciprocating motion.

The end of the sludge suction head of the sludge sucker in FIG. 7 and FIG. 8 is provided with the transition guide roller, and correspondingly the upper and lower horizontal portions of the sewage tank are respectively provided with a transition guide rail. The transition guide rollers on two ends of the sludge suction head are sleeved in the transition guide rails. The upper part of the sewage tank is provided with a liquid level sensor. The end portion of the transition guide rail is provided with a limiting sensor limiting the travel distance of the sludge sucker.

The front end of the sewage tank of the two fibrous filter tanks is connected with a water inlet groove, the rear end of the filtrate tank is connected with a water outlet channel, and an effluent weir is arranged between the filtrate tank and the water outlet channel. The liquid level of the filter tank is lower than the liquid level of the sewage tank, and the upper edge of the filter hole is located below the liquid level of the filtrate tank. The filter plate includes filter cloth and a filter cloth support, and the filter cloth is fixed on the filter cloth support.

A sewage treatment method of the two fibrous filter tanks are as follows: filter holes are symmetrically arranged between the sewage tank and the filtrate tank. The filter plate is fixedly installed on the filter holes. Sewage in the sewage tank is filtered by the filter plate to enter the filtrate tank. One side of the sewage tank of the filter plate is provided with the sludge sucker. The sludge sucker makes up-down or horizontal synchronous motion in opposite directions to suck the sludge under the action of the driving mechanism. When the filter plate is blocked, the liquid level of the sewage in the sewage tank rises. When the liquid level of the sewage in the sewage tank reaches the liquid level set by the liquid sensor, the sludge sucker is controlled and started to back suck the sludge on the filter plate. At the same time, the driving mechanism is started to drive the sludge sucker to make up-down or horizontal synchronous motion in opposite directions to suck away the sludge on the filter plate, so that the filter plate can restore the filter capacity.

What is claimed is:

1. A treatment method for rural black and odorous water and manure, comprising:
(1) sending manure into a solid-liquid separation system, adding an appropriate amount of straws and/or saw-dust and chaff into solid obtained after the solid-liquid separation, adjusting a carbon-nitrogen ratio to 20-30 and water content to 50%-70%, then sending into a solid aerobic fermentation system for aerobic fermentation, and then aging to obtain organic fertilizer;
(2) sending the manure into the solid-liquid separation system, homogenizing liquid obtained after the solid-liquid separation by a regulating tank, and sending into a liquid anaerobic fermentation system for deep anaerobic fermentation;
(3) sending biogas slurry after the deep anaerobic fermentation in step (2) to a bio-membrane filter tank for aerobic biochemical treatment, sending sewage treated by the bio-membrane filter tank into a fibrous filter tank for filtering, and making the sewage reach requirements of relevant farmland irrigation water quality standard and emission standard;
(4) carrying out the water-fertilizer integrated irrigation for peripheral crops using one part of the liquid treated in step (3), and sterilizing the other part to be reused for flushing fences;
(5) in a region where the straws can be collected, arranging straw hydrolysis tanks, loading the manure slurry into the straw hydrolysis tanks, cutting the straws into segments, soaking the straw segments in manure slurry of the straw hydrolysis tanks for hydrolysis, wherein the straw hydrolysis tanks are multiple; after the straws soaked in one straw hydrolysis tank reach the soaking time, pumping the softened straws into the solid-liquid separation system by using a cutting pump, mixing the straws obtained from the solid-liquid separation with manure, adjusting the carbon-nitrogen ratio to 20-30, and sending to the solid aerobic fermentation system for aerobic fermentation to produce organic fertilizer; and homogenizing the liquid obtained from the solid-liquid separation by the regulating tank, sending to the liquid anaerobic fermentation for anaerobic fermentation, carrying out the aerobic biochemical treatment in the bio-membrane filter tank, then sending into the fibrous filter tank for filtering, and making the sewage meet the requirements of relevant farmland irrigation water quality standard and emission standard.

2. A treatment system for rural black and odorous water and manure, comprising a solid-liquid separation system, a solid aerobic fermentation system, a liquid anaerobic fermentation system, a bio-membrane filter tank, a fibrous filter tank, a cutting pump, connection pipelines and a straw hydrolysis tank, wherein a manure outlet is connected with the solid-liquid separation system and/or the manure outlet is connected with the straw hydrolysis tank, and straws of the straw hydrolysis tank are conveyed to the solid-liquid separation system through the cutting pump and the connection pipeline; solid of the solid-liquid separation system is conveyed to the solid aerobic fermentation system, and the output of the solid aerobic fermentation system is aged to produce the organic fertilizer; and liquid separated from the solid-liquid separation system is outputted to the regulating tank, sewage of the regulating tank is connected and conveyed to the liquid anaerobic fermentation system, biogas slurry outputted by the liquid anaerobic fermentation system is connected to the bio-membrane filter tank, the sewage treated by the bio-membrane filter tank is sent to the fibrous filter tank, and the filter water of the fibrous filter tank is used for farmland irrigation or reuse.

3. The treatment system for rural black and odorous water and manure according to claim 2, wherein the solid-liquid separation system comprises a spiral squeezing solid-liquid separator and an inclined-sieve solid-liquid separator; and the liquid squeezed by the spiral squeezing solid-liquid separator is conveyed to the inclined-sieve solid-liquid separator for continuous solid-liquid separation.

4. The treatment method for rural black and odorous water and manure according to claim 1, wherein the liquid anaerobic fermentation system is formed by connecting N anaerobic soft boigas digesters in series; N≥1; when the quantity of the anaerobic soft biogas digesters is greater than 1, the first anaerobic soft biogas digester with liquid feed is an anaerobic hydrolysis acidification tank, and the total capacity of the anaerobic soft biogas digesters connected in series is designed to be ten times or more than ten times of the liquid volume fed everyday to ensure the full anaerobic fermentation of the produced liquid; the bottoms of the biogas digesters descend gradually, the bottom of the previous anaerobic soft biogas digester has a sludge guiding pipeline connected with the next anaerobic soft biogas digester, so that sludge settled in the previous biogas digester flows to the next biogas digester through the sludge guiding pipeline; and a sludge discharging pipe arranged at a lowest position on the bottom of each anaerobic soft biogas tank can periodically discharge the sludge to prevent the accumulation of the sludge inside the anaerobic soft biogas digester, and the supernatant of the last biogas digester flows into the bio-membrane filter tank.

5. The treatment method for rural black and odorous water and manure according to claim 1, wherein biogas generated by the liquid anaerobic fermentation system provides a heat source to a reactor of the solid aerobic fermentation system for realizing the high-temperature aerobic fermentation and/or provides the heat source to the liquid anaerobic fermentation system for realizing medium-temperature anaerobic fermentation, and provides the heat source to breeding sheds for livestock and poultry breeding.

6. The treatment method for rural black and odorous water and manure according to claim 1, wherein the bio-membrane filter tank refers to a bio-turnplate bio-membrane biochemical reactor or a submerged lifting cycling bio-membrane filter tank.

7. The treatment method for rural black and odorous water and manure according to claim 6, wherein the submerged lifting cycling bio-membrane filter tank adopts two groups of filter screens which have equal weight and are symmetrically and alternately distributed; under the action of a lifting mechanism, the two groups of filter screens rise and fall periodically in the bio-membrane filter tank, so that bio-membranes on the two groups of filter screens contact the air and sewage in turn; the bio-membranes absorb organic matters in the sewage when descending and submerging, and absorb oxygen when rising in the air so as to bring the oxygen into the sewage during the next descending and submerging and to cause the turbulence of the sewage in a water channel, so that the dissolved oxygen is uniformly distributed, and the sewage is purified.

8. The treatment method for rural black and odorous water and manure according to claim 1, wherein the fibrous filter tank adopts a reciprocating-suction fibrous filter tank; filter holes are symmetrically arranged between a sewage tank and a filtrate tank; a filter plate is installed and fixed on the filter holes; sewage in the sewage tank is filtered by the filter plate to enter the filtrate tank; one side of the sewage tank of the filter plate is provided with a sludge sucker; the sludge sucker makes up-down or horizontal synchronous motion in opposite directions to suck the sludge under the action of the driving mechanism; when the filter plate is blocked, the liquid level of the sewage in the sewage tank rises; and when the liquid level of the sewage in the sewage tank reaches a liquid level set by a liquid sensor, an electric control system controls and starts the sludge sucker to back suck the sludge on the filter plate and also starts the driving mechanism to drive the sludge sucker to make up-down or horizontal synchronous motion in opposite directions to suck away the sludge on the filter plate, so that the filter plate can restore the filter capacity.

9. The treatment method for rural black and odorous water and manure according to claim 1, wherein the straws are cut into straw segments with a length of 1-3 cm.

10. The treatment method for rural black and odorous water and manure according to claim 1, wherein the liquid obtained after the solid-liquid separation is sent into the liquid anaerobic fermentation system for deep anaerobic fermentation for more than 20 days.
